(19) United States
(12) Patent Application Publication
(10) Pub. No.: US 2003/0090431 A1
(43) Pub. Date: May 15, 2003

(54) Dual-polarized dipole array antenna

(76) Inventor: Maximillan Gottl, Frasdorf (DE)

Correspondence Address: NIXON & VANDERHYE, PC, 1100 N GLEBE ROAD, 8TH FLOOR, ARLINGTON, VA, 22201-4714, US

(21) Appl. No.: 10/221,753

(22) PCT Filed: Mar. 15, 2001
(86) PCT No.: PCT/EP01/02962

(30) Foreign Application Priority Data
Mar. 16, 2000 (DE) 100 12 809.2

(51) Int. Cl. H01Q 21/26

(52) U.S. Cl. 343/797

(57) ABSTRACT

The invention relates to an improved antenna that is characterized in that the supply (33, 35) of the antenna with respect to the two orthogonal parallel dipoles (113, 115) of a dipole square (3, 5) is provided in such a manner that a supply cable (27) is connected to a feeder point (33) on a dipole (13″, 15″) and that starting from said feeder point (33) a connection cable (37) to the feeder point (35) on the respective orthogonal parallel dipole (13′, 15′) of the dipole square (3, 5) is laid and is electrically connected there to the dipole halves (13′, 15′) of the dipole square (3, 5).

The invention relates to a dual-polarized dipole antenna according to the preamble of claim 1.

From DE 198 23 749 A1, a dual-polarized dipole antenna has become known which, in particular, is suitable for the mobile radio networks used throughout the world, particularly the GSM900 or GSM1800 network for transmission in the 900 MHz or 1,800 MHz band.

In the generic dual-polarized antenna which has become known, a polarization orientation of ±45° is used. In a joint antenna housing, in front of a reflector, a number of such dipole squares are usually arranged in the vertical direction for transmitting in one frequency band and, for example, a further different dipole square for transmitting in the other frequency band is arranged, for example, between in each case two such dipole squares arranged vertically above one another.

The horizontal half-power beam width of the antenna, which is mainly used, is 65°. To make the antennas as compact as possible, two single dipoles are connected together with the same phase in order to achieve the 65° half-power beam width for each polarization. The dipoles are oriented at +45° and −45°, respectively. This results in a so called dipole square,

The two horizontal radiation patterns of the +45° and −45° polarizations should be oriented to be coincident, if possible. Any deviation is called tracking.

To achieve a narrower vertical half-power beam width and to increase the antenna gain, a number of dipole squares are connected together in the vertical direction. If this is done in phase, the two antennas polarized by +45° and −45° do not have any electrical depression. With an antenna dimensioned as well as this, there is no tracking, either, or it can be called minimal. The cross-polarized components of the radiation pattern are also minimal.

Today, it is mainly the ±60° sector which is of significance for mobile radio. In recent years, the networks have become ever more dense due to the great success of mobile radio. The existing frequencies must be used more economically and used at closer and closer distances. It the coverage is too dense, interferences are produced. A remedy can be achieved by using antennas having a greater electrical depression, for example a depression angle of up to 15°. However, this has the unpleasant side effect that as the depression angle increases, the two horizontal patterns of the dual-polarized antennas drift apart, i.e. that the horizontal pattern polarized +45° drifts in the positive direction and the horizontal pattern polarized −45° drifts in the negative direction. This leads to considerable tracking with large depression angles. Furthermore, the tracking is frequency-dependent. Similarly, the cross-polarized components of the radiation pattern follow the horizontal patterns which leads to a distinct deterioration in the polarization diversity characteristics in the ±60° sector.

It is, therefore, the object of the present invention to overcome the disadvantages of the prior art and to create an improved dual-polarized antenna.

According to the invention the object is achieved in accordance with the features specified in claim 1. Advantageous embodiments of the invention are specified in the subclaims.

It must be described as completely surprising that it is now possible to ensure with comparatively simple means in the generic dual-polarized dipole antenna, even with a comparatively great depression that the horizontal patterns do not drift apart or, at least, the drifting-apart is distinctly minimized, and thus improved with respect to the prior art. On the other hand, the solution according to the invention also provides possibilities still to achieve a particular tracking, if required, for example in the case of a non-depressed radiation pattern. The resultant improved compensation for the tracking in dependence on frequency is also surprising.

Due to the fact that the tracking is eliminated or at least minimized in accordance with the invention, the cross-polarized components of the radiation pattern are also distinctly improved. As a consequence, the polarization diversity characteristics are also improved.

A further advantage is also that the overall expenditure of cables can be reduced compared with conventional antenna installations.

The surprising solution according to the invention is based on the fact that in each case the two opposite parallel dipoles of a dipole square which radiate or, respectively, receive with the same polarization are not fed in parallel or with balanced cables or with separate cables but that the feeding only takes place with respect to one dipole and from the feed point at one dipole a connecting cable is then provided to the feed at the opposite second, parallel dipole.

Due to the feeding according to the invention, orienting the radiators to +/−45° causes a frequency-dependent squinting of the dipole squares and thus also a drift of the patterns in the horizontal and in the vertical direction. It must then be described as completely surprising that this leads to a wide-band improvement in the tracking and additionally reduces the cross-polarized components without, however, impairing the electrical depression. This is all the more surprising as the interconnection of the dipoles according to the invention results in a most unwanted narrow-band characteristic of the antenna from the point of view of the expert and, in addition, a disadvantageous frequency-dependence of the depression angle would be expected.

In a preferred embodiment of the invention, it is provided that the electrical length of the connecting cable corresponds to one wavelength λ or an integral multiple thereof referred to the center frequency to be transmitted.

Since such antennas usually do not comprise only one dipole square but a number of dipole squares arranged, as a rule, above one another in the vertical direction of installation and aligned at a 45° angle to the vertical, the tracking can now be preset differently in accordance with the requirements. In a preferred embodiment of the invention, this can be effected, for example, by the feeding, coming from the feed cable, taking place in each case only at the same side of dipoles aligned with the corresponding polarization and, coming from there, connecting cables leading to the in each case opposite dipole in the same manner for all dipoles.

A change in the amount of tracking, however, can be implemented by the fact that, for example, the feeding of four dipole squares arranged one above one another in each case takes place with reference to the dipole on the left in three dipole squares with respect to the dipoles arranged in parallel with one another and only with respect to one dipole square does it take place only with respect to the dipole parallel thereto on the right.

If, for example, referred to four dipole squares, the feeding is only effected at the dipoles on the left in the case of two dipoles and the other half of the feeding is effected only at the dipoles on the right (the feeding with respect to the in each case second parallel dipole taking place via the connecting line), a different value is obtained for the tracking.

In other words, the degree and the magnitude of the compensation value for the drifting-apart of the +45° and −45° polarized horizontal pattern component can be set correspondingly finely and compensated for by the different proportion at which one of in each case two dipoles oriented in parallel with one another the initial feeding takes place and which dipole is fed via a connecting line coming from there.

In the field of the dual- or cross-polarized antenna explained, the series feed, which can be selected differently if necessary, can be used for compensating for the frequency-dependence of the radiation patterns and for compensating for the tracking which is completely surprising and not obvious.

However, the solution according to the invention also provides the further advantage that only one feed cable, provided with a cross section of correspondingly large dimension, to in each case two dipoles located offset by 90° is provided and that from these two dipoles, in each case only one connecting cable, provided with a thinner cable cross section, must be conducted to the in each case opposite dipole of a dipole square. This distinctly reduces the overall cable expenditure.

Further advantages and details of the invention are found in the example explained in the text which follows by means of drawings, in which, in detail:

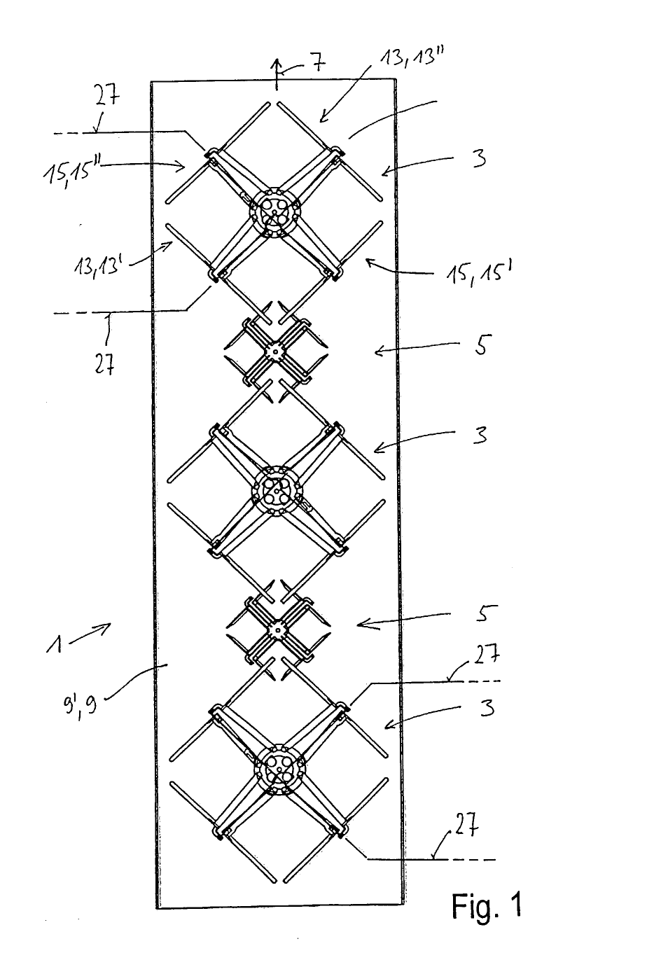

FIG. 1 shows a dual-polarized dipole antenna comprising a number of dipole squares;

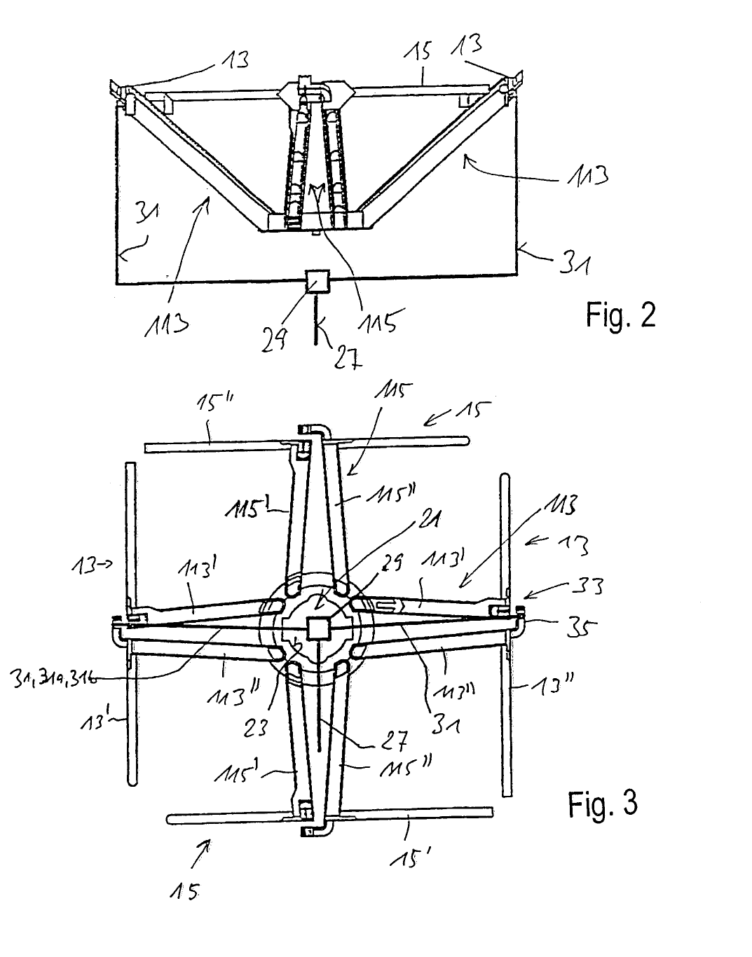

FIG. 2 shows a diagrammatic side view of a dipole square along the direction of arrow A in FIG. 1 with cabling according to the prior art;

FIG. 3 shows a top view of the dipole square of FIG. 2 of the prior art;

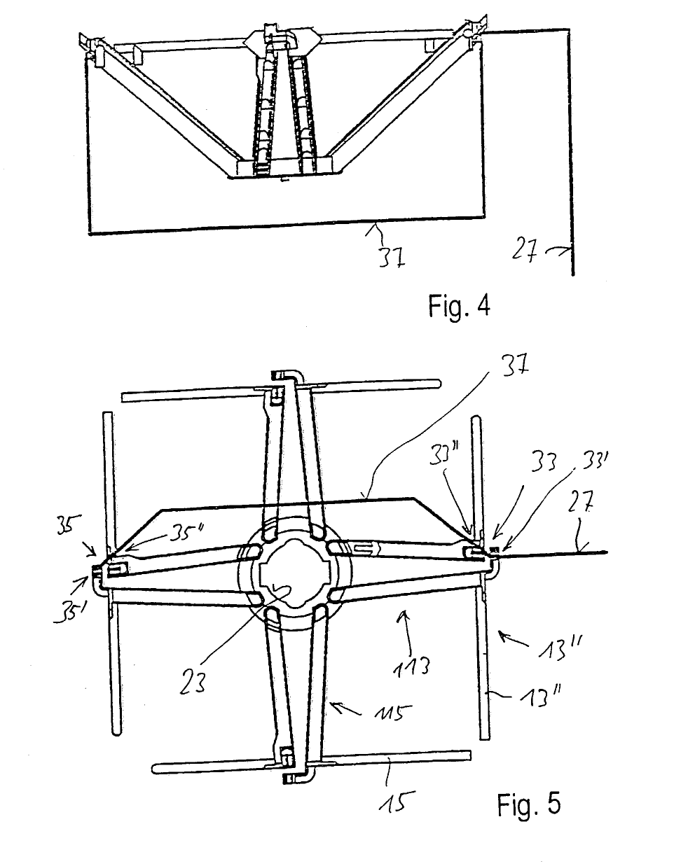

FIG. 4 shows a corresponding representation of FIG. 2 according to the solution according to the invention; and

FIG. 5 shows a top view of the exemplary embodiment according to FIG. 4;

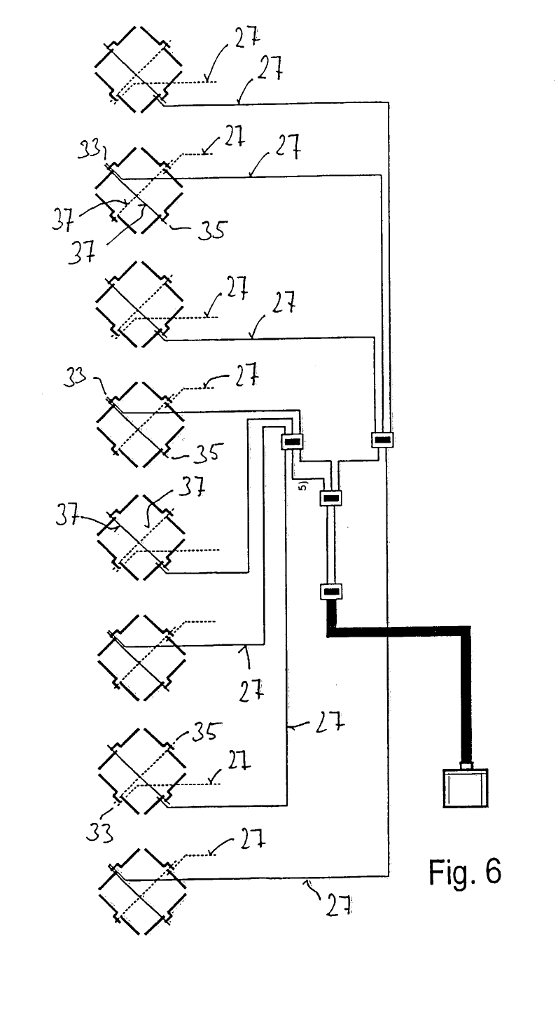

FIG. 6 shows a diagrammatic representation of eight dipole squares, arranged vertically above one another and rotated by 45° inclination, with differently located feed points;

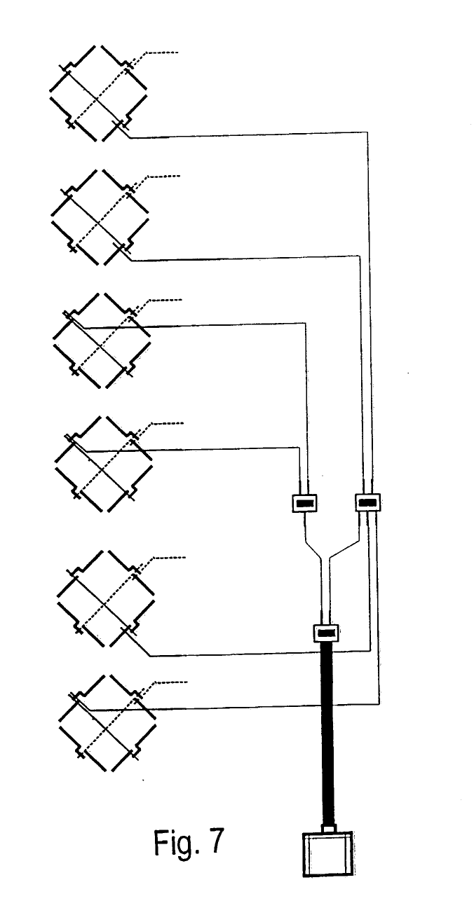

FIG. 7 shows an exemplary embodiment, again slightly modified, with six dipole squares arranged above one another and with differently located feed points.

FIG. 1 shows a diagrammatic top view of a dual-polarized dipole antenna 1 having a number of first dipole squares 3 and a number of second dipole squares 5. The first dipole squares 1 are used, for example, for transmitting in the 900 MHz band, The second dipole squares 5 of comparatively smaller dimensions are tuned, for example, for transmission in the 1,800 MHz band. All dipole squares 3 and 5 are oriented inclined by 45° with respect to the vertical and horizontal and arranged along a vertical mounting direction 7 above one another in front of a reflector 9 at a suitable distance in front of the reflector plate 9′.

With respect to the basic configuration and operation, reference is made to the previously published prior art according to DE 198 23 749 A1 to the content of which reference is made in its full extent and which is incorporated as content of the present application.

These dipole squares, which are basically previously known, have a configuration and a feed according to FIGS. 2 and 3 of the present application.

The dipole squares in each case comprise two pairs of parallel dipoles 13 and 15 which, according to the top view of FIG. 4, are arranged in the manner of a dipole square. Both dipole pairs 13′ and 13″ and the two dipole pairs 15′ and 15″ are carried and held via a balancing arrangement 113′ and 113″ and, respectively, 115′ and 115″ which, in the exemplary embodiment shown, extend from a base and anchoring area 21 on the reflector 9 with a vertical and in each case outwardly pointing component to the dipole halves located at a distance in front of the reflector 9. A first connecting cable 31 (coaxial cable) is conducted, usually via a hole 23 in the reflector 9, from a feed cable 27 coming behind the reflector 9 in the area of the base point or the anchoring area 21 via a branching point 29 along one support arm of the balancing arrangement 113 to the feed point 33 at which the external conductor 31a is electrically joined, for example to the support arm 113′, and the internal conductor 31b is constructed, separately from this, extended in the axial longitudinal direction over a small distance and is electrically connected to a connecting point or elbow 35 connected to the second dipole half.

The same joining connection is made for the opposite dipole. The electrical feed to the two dipole pairs, located offset by 90°, which are not drawn in FIGS. 2 and 3 for the sake of clarity, is effected via a separate second feed cable and two further separate connecting lines.

By comparison, according to the invention, a feed according to FIGS. 4 and 5 is now carried Out in which the feed cable 27 (a coaxial cable) is conducted directly to the feed point 33 at a dipole. The feed cable 27 is there again electrically connected to the feed point 33′ (which is connected to one dipole half) with its internal conductor and the external conductor 31b is electrically connected to the other dipole half at feed point 33′.

From this feed point 33, a connecting cable 37 comes which leads to the feed point 35 at the opposite dipole half. In this arrangement, the inner conductor is again electrically connected to one dipole half via the connecting point 35′ and the outer conductor is connected to the second dipole half at 35″.

In practice, the feed cable is run here, too, via the hole 23 at one support arm or in one support arm of the balancing arrangement 113′ or 113″ (if this is constructed, for example, as a waveguide or hollow support) in the interior and conducted to the feed point 33 where the outer conductor is electrically connected to one dipole half and the inner conductor is connected to the connecting point of the second dipole half. The coaxial connecting cable 37 is similarly conducted back again in the direction of the reflector plate 9′ from the feed point 33 at one dipole at or, for example, in the second support arm 113′ or 113″ of the corresponding balancing arrangement 113 and conducted in the possibly hollow support arm of the opposite balancing arrangement 113 of the opposite dipole 13′ to its feed point 35 located at the top. Similarly, however, it can be run at the balancing arrangement or in another suitable manner. FIGS. 1, 4 and 5 only show the principle of interconnection which is why the respective feed cable 27 is shown conducted to the feed point coming virtually from the outside although, in practice, it is conducted along the balancing arrangement to the feed point 33 coming via the central hole 23.

The length of the connecting cable should then be λ or an integral multiple thereof referred to the frequency range to be transmitted, particularly the center frequency range.

Correspondingly, the feeding to the two dipoles 15 and 115, located offset by 90° in the exemplary embodiment of FIGS. 4 and 5, is carried out via a separate feed cable or a corresponding separate connecting cable. There, too, a feeding via a separate feed cable takes place first at one dipole 15′ and at a feed point constructed there, and from there a separate connecting cable is then conducted to an opposite dipole 15″ and connected to a corresponding feed point.

FIG. 1 shows by way of example that the dipole halves 13′ and 15′, located on the left in each case, are fed there at a corresponding feed point 35 via two separate feed cables 27 and that connecting cables 31 lead from there to the in each case opposite dipoles 13″ and 15″, respectively, to feed points provided there.

Thus, for example, all dipole squares 3 which are larger in FIG. 1, but also all smaller dipole squares 5, can be fed in the same manner.

However, it is also possible that, for example, a single dipole square or, in the case of even more dipole squares arranged above one another vertically, for example one half or any other combination of dipole squares are fed differently. Thus, it is shown, for example with respect to the lowest dipole square 3 in FIG. 1, that there, feeding takes place via two separate feed cables at the dipoles on the right in the dipole square, namely at dipole 13″ and dipole 15″, namely at the feed points explained. The feeding at the opposite parallel dipole is then carried out in each case starting from the first feed point via two separate connecting lines 31:.

Depending on whether in each case firstly the first feeding takes place and which of the dipoles, which are in each case parallel in pairs, of a dipole square is connected electrically by the connecting line starting from the first dipole, a different measure of the tracking is also obtained.

FIGS. 6 and 7 show two examples of one set of eight dipole squares arranged one above another in 45° orientation which, to achieve a quite particular value for the tracking, exhibit different feeding once with respect to the dipoles on the left or with respect to the dipoles on the right. This correspondingly applies to the exemplary embodiment according to FIG. 7 which shows six dipole squares arranged above one another in 45° orientation. The feeding for the various dual-polarized dipole squares is implemented starting in each case from a main feed line 27 via subsequent distributors and taps. The reflector plate is not drawn in in FIGS. 6 and 7.

1. A dual-polarized dipole antenna in the form of one or a number of dipole squares (3, 5), the dipole square or squares (3, 5) being oriented rotated at a 45° angle with respect to the vertical or horizontal, characterized in that a feed arrangement (33, 35) with respect to two first dipoles (113) located offset with respect to one another in parallel and with respect to further dipoles (115) arranged rotated by 90° with respect to the first parallel dipoles (113) and also located offset to one another in parallel, of the dipole square (3, 5) is effected in such a manner that a feed cable (27) is conducted to a feed point (33) at a first dipole (13″) and a further feed cable (27) is conducted to a second dipole (15″), and in that, coming from these feed points (33), one connecting cable (37) each is run to the respective feed point (35) at the respective opposite parallel dipole (13′, 15′) of the dipole square (3, 5) and is there electrically connected to the respective remaining dipole halves (13′, 15′) of the dipole square (3, 5).

2. The antenna as claimed in claim 1, characterized in that the electrically effective length of the connecting line or of the connecting lines (31), respectively, is at least approximately λ or an integral multiple thereof with respect to the frequency band arranged to be transmitted, particularly with respect to the center frequency.

3. The antenna as claimed in claim 1 or 2, characterized in that where there is a number of dipole squares (3, 5) arranged above and/or next to one another along a direction of installation (7), the feed points (33) connected to the feed cables (27) are located at a correspondingly identical point or orientation at all dipole squares (3, 5).

4. The antenna as claimed in claim 1, or 2, characterized in that where there is a number of dipole squares (3, 5) arranged above and/or next to one another along a direction of installation (7), the feed points (33) connected to the feed cables (27) are located at the respective other one of the dipoles (13, 15), which are in each case parallel with one another in pairs, of the dipole squares (3, 5) in the case of at least one of the dipole squares (3, 5) or in a part of all dipole squares (3, 5).

5. The antenna as claimed in one of claims 1 to 4, characterized in that the connecting lines (27) are in each case run from the first feed point (33) at one dipole (13″, 15″) to the respective feed point (35) at the dipole (13′, 15′) parallel thereto at or in the support arms, possibly constructed to be hollow, of the balancing arrangements (113, 115) of the dipoles (13, 15).

6. The antenna as claimed in one of claims 1 to 5, characterized in that the connecting cables (37) have a different line cross section, particularly a thinner line cross section for the inner conductor and/or for the outer conductor than the feed lines (27) conducted to the first feed point (33).

7. The antenna as claimed in one of claims 1 to 6, characterized in chat a reduction in the frequency-dependence of the orientation of the copolar and/or cross polar radiation patterns (tracking) can be obtained in dependence on the feeding arrangement at each dipole square.
